(19) United States
(12) Patent Application Publication
(10) Pub. No.: US 2014/0220806 A1
(43) Pub. Date: Aug. 7, 2014

(54) PORTABLE PLUG ADAPTER WITH WIRELESS TRANSCEIVER MODULE

(71) Applicant: Cho-Liang Liang, Taipei (TW)

(72) Inventor: Cho-Liang Liang, Taipei (TW)

(21) Appl. No.: 13/758,934

(22) Filed: Feb. 4, 2013

(51) Int. Cl. H01R 24/68

(52) U.S. Cl. CPC H01R 24/68
USPC 439/284

(57) ABSTRACT

A plug adapter with wireless transceiver module with universal plug & socket assembly is combined with a wireless transceiver module. Firstly, a wireless transceiver module is set into the portable plug adapter without worry about the difference of plugs; furthermore, it is possible to share wireless connection via either of 3G, 4G, WIMAX and WIFI. And, an input interface and at least one connection port are set externally and connected electrically to provide wired network input and output; if wireless signals are output via the wireless transceiver module, many users could share network resources. Additionally, a USB connector is connected with an electronic device for electric charging, thus realizing ease of use via the integrated design of the present invention.

### BACKGROUND OF INVENTION

1. Field of the Invention

The present invention relates generally to a portable plug adapter, and more particularly to a plug adapter which contains universal plug& socket assemblies combined with a wireless transceiver module.

2. Description of Related Art

Currently, portable electronic devices are generally provided with wireless networking functions available for on-line searching and communication at any time; however, many hotels only provide a single wired cable for tourists, making it hard to meet the needs of multiple portable wireless electronic devices or a group of users; besides, even if wireless network is available, sometimes wireless networking signals are very weak due to ambient environment, so a wireless router is a helper for smooth networking.

Furthermore, it is inconvenient for those who often go abroad for a business tour or take a trip while carrying a plug adapter with universal plug & socket assemblies to be connected with a wireless router. An investigation has shown that the present wireless transceiver module is small-sized, lightweight and multi-functional. Hence, the wireless transceiver module could be accommodated into a plug adapter with universal plug & socket assemblies, which is not yet publicly available in the market.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The primary objective of the present invention is to provide an integrated solution of portable electronic device. In consideration of network-dependent applications, a successful integrated program is developed by applying a wireless network module of wired input and wireless output to a portable universal plug& socket adapter.

Another objective of the present invention is to provide a plug adapter with universal plug & socket adapter and power supply, whilst a wireless network module is configured to convert wired network into wireless one, sharing network resources with multiple individuals and devices.

The present invention is to provide a portable plug adapter with wireless transceiver module, namely, a portable plug adapter containing universal plug & socket assembly is combined with a wireless transceiver module; the advantages lie in that, when traveling abroad, there is no need to worry about the difference of plugs, and a wireless transceiver module is set inside the portable power converter, enabling wireless connection by either of 3G, 4G, WIMAX and WIFI; moreover, an input interface and at least a connection port are set externally and connected electrically for wired input and output; then wireless signals are sent out by the wireless transceiver module, helping multiple individuals to share the network resources; additionally, a Universal Serial Bus (USB) connector is linked with the electronic device. So, the present invention features ease-of-use through design integration.

The structure, technical means and efficacies of the present invention will be more readily understood with reference to the accompanying drawings and preferred embodiments:

### BRIEF DESCRIPTION OF THE DRAWINGS

FIG. 1 is a perspective exploded circuit view of a preferred embodiment of the present invention;

FIG. 2 is a part view of a preferred embodiment of the present invention.

FIG. 3 is a full combination view of a preferred embodiment of the present invention;

FIG. 4 is a block diagram of circuit function of a preferred embodiment of the present invention;

FIG. 5 is a diagram of wired network input and wireless launch of a preferred embodiment of the present invention;

FIG. 6 is a perspective view of another preferred embodiment of the present invention; and

FIG. 7 is diagram of wired network input and wireless launch of another preferred embodiment of the present invention.

### DETAILED DESCRIPTION OF THE INVENTION

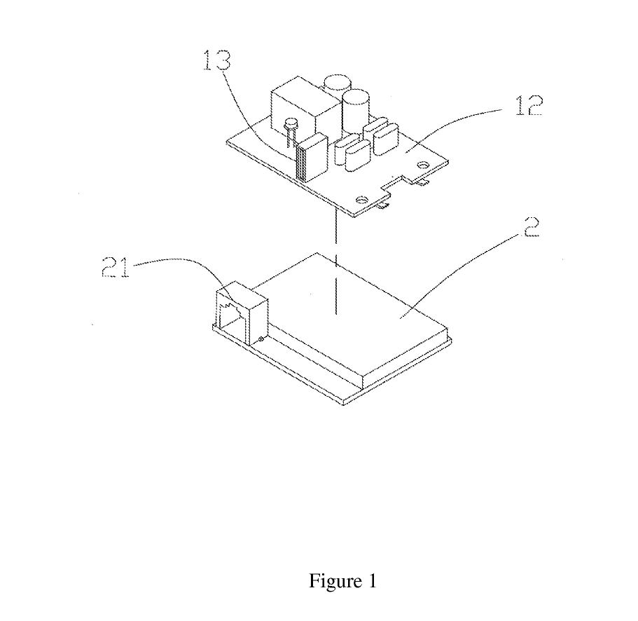

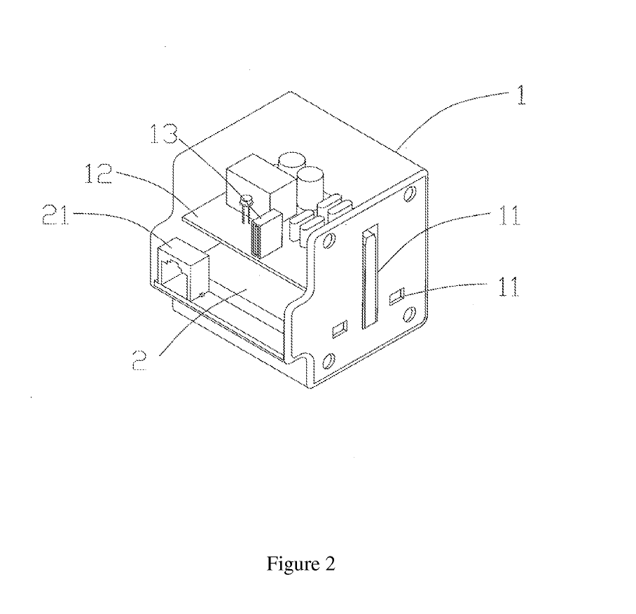

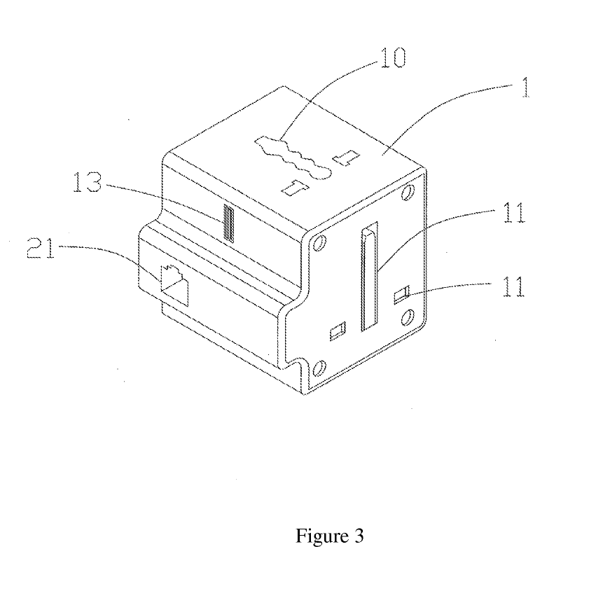

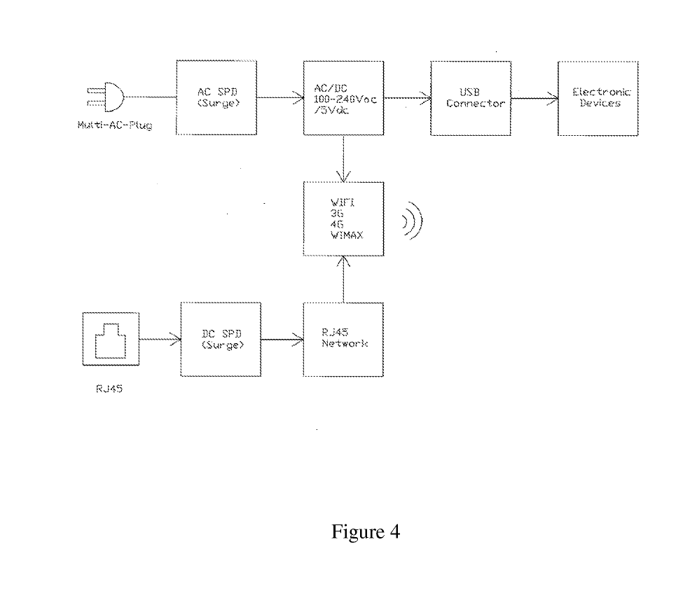

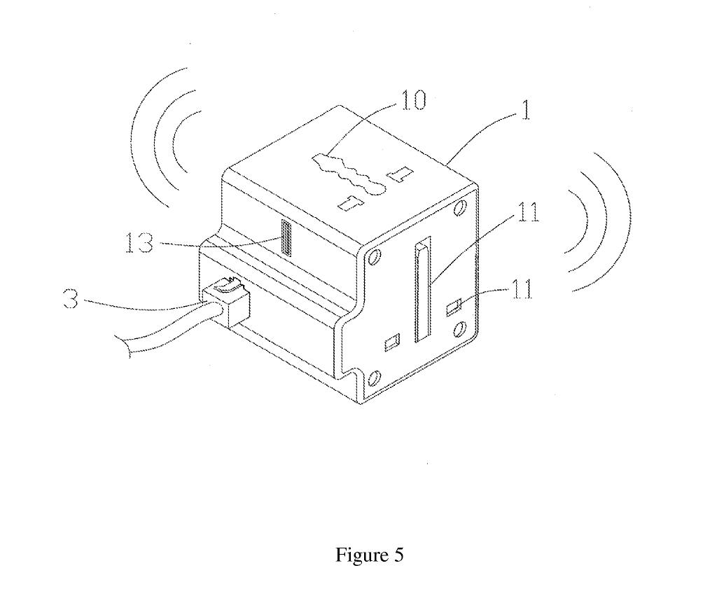

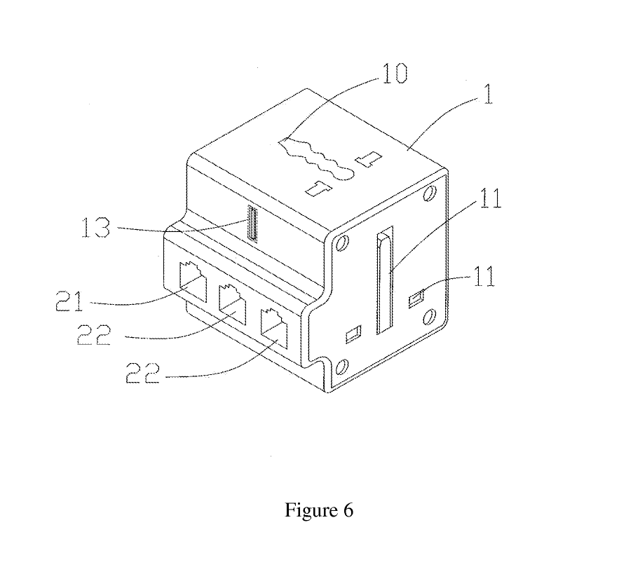

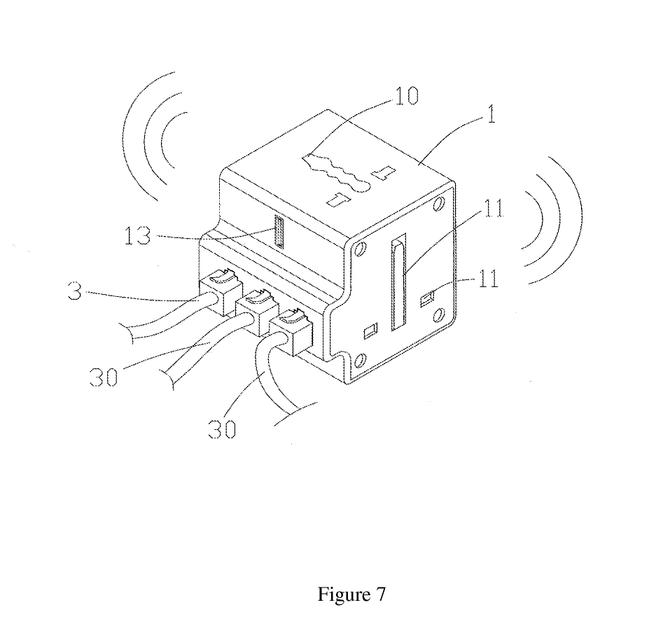

The present invention is a portable plug adapter with wireless transceiver module; FIG. 1 depicts a perspective exploded circuit diagram of a preferred embodiment of the present invention; FIG. 2 depicts a partial assembled view; FIG. 3 depicts an assembly view; FIG. 4 depicts a block diagram of circuit functions; FIG. 5 depicts a schematic view of wired network input and wireless transmission; FIG. 6 depicts a perspective view of another preferred embodiment of the present invention; FIG. 7 depicts a schematic view of wired network input/out and wireless transmission; the portable power converter of the present invention with wireless transceiver module mainly comprises: a plug adapter 1, and a wireless transceiver module 2.

The plug adapter 1 refers to an assembly of universal plug and socket, which comprising: a socket 10 and at least one set of plug pin 11 with various patterns; the present invention is described with icons, of which the socket 10 is electrically connected with the plug pins 11, which can be plugged into the universal power socket; the power converter 1 is provided with a circuit board 12 with Surge Protection Device (SPD), which is divided into AC SPD and DC SPD; then AC/DC power switching circuit is integrated, while a USB connector 13 is set on external surface to provide DC output.

The wireless transceiver module 2 is embedded into the plug adapter 1, the circuit board 12 is electrically connected with the wireless module 2; an electrically connected input interface 21 and at least one connection port 22 are set on external surface of the power converter 1; the input interface 21 and connection port 22 are of RJ45 network adapter; and the input interface 21 is connected to a wired network 3, the connection ports 22 are connected to multiple network communication devices via wired cables 30; the wireless transceiver module 2 receives information of the wired network 3 through the input interface 21, and transmits the information by its wireless transmission function for sharing information; of which the wireless transceiver module 2 can share wireless connection by either of 3G 4G WIMAX and WIFI. It is also configured that wireless module 2 is able to receive wireless signal and creates inline connection of transmission signals through the input interface 21.

Referring to FIG. 4—a block diagram of circuit function of the present invention, the present invention refers to a plug adapter 1 with universal plug & socket assembly, which can generate DC output via AC surge protection device (SPD) and AC/DC power switching circuit, and also supply power for wireless modules 2 and USB connector 13; besides, the USB connector 13 is connected to other electronic devices for electric charging. Moreover, DC input sources refer to input signals of wired network 3, which are connected via RJ45 network adapter; this could transmit information to the wireless module 2 via DC surge protection device (SPD), so as to share the wireless information.

Referring to FIG. 5—a schematic view of wired network 3 and wireless transmission, a wired network 3 is used for input and wireless transmission, helping to share information via wireless information transmission; however, it is weak in protection and privacy for information. Referring to FIGS. 6, 7—another preferred embodiment of wired network 3 and wireless transmission in the present invention with at least one connection port 22. In this embodiment, two connection ports 22 are set on the external surface of the plug adapter 1, and connected with the input interface 21 via wired network line 30, so electronic devices with network communication functions, such as Internet phones, computers and TVs, are connected separately with various connection ports 22 to ensure the protection and privacy for information transmission.

To sum up, the present invention is developed for the applications of portable plug adapter with universal plug & socket assemblies combined with wireless transceiver module. With input interface and wireless module, the present invention allows to share network resources and realize wireless transmission. Furthermore, it could improve the convenience of networking during travel; and USB connector is linked to electronic devices for convenient charging and use. So, the product with added value features strong industrial applicability and practical value as an excellent innovative design, hence the patent claims are made hereto.

Although the invention has been explained in relation to its preferred embodiment, it is to be understood that many other possible modifications and variations can be made without departing from the spirit and scope of the invention as hereinafter claimed.

1. A portable plug adapter with wireless transceiver module, which comprising:
a plug adapter, provided with at least one plug and a socket, a circuit board and also electrically connected with at least one plug and a socket;
a wireless module, embedded into the plug adapter and electrically connected with the circuit board, of which an input interface is electrically connected and set on external surface of the power converter; the wireless transceiver module receives wired network information via the input interface, and generates wireless transmission signals to realize wireless information transmission.

2. The portable plug adapter with wireless transceiver module as claimed in claim 1, wherein said plug adapter is provided with at least one set of plug pins of different structural patterns.

3. The portable plug adapter with wireless transceiver module as claimed in claim 1, wherein said wireless transceiver module is electrically connected with at least one connection port, of which said connection port is connected with network communication device via a wired network.

4. The portable plug adapter with wireless transceiver module as claimed in claim 1, wherein said wireless module could share wireless connection via either of 3G, 4G, WIMAX and WIFI.

5. The portable plug adapter with wireless transceiver module as claimed in claim 1, wherein said plug adapter is provided with a circuit board with Surge Protective Circuit.

6. The portable plug adapter with wireless transceiver module as claimed in claim 1, wherein said plug adapter is provided with a circuit board with AC/DC power switching circuit.

7. The portable plug adapter with wireless transceiver module as claimed in claim 1, wherein a USB connector is set on the external surface of the plug adapter.

8. The portable plug adapter with wireless transceiver module as claimed in claim 1, wherein said wireless module receives wireless signal, and creates inline connection of transmission signals through the input interface.
